(19) United States
(12) Patent Application Publication
(10) Pub. No.: US 2013/0062990 A1
(43) Pub. Date: Mar. 14, 2013

(54) COIL BACK YOKE, CORELESS ELECTROMECHANICAL DEVICE, MOBILE BODY, ROBOT, AND MANUFACTURING METHOD FOR COIL BACK YOKE

(71) Applicant: Kesatoshi TAKEUCHI, Shiojiri (JP)

(72) Inventor: Kesatoshi TAKEUCHI, Shiojiri (JP)

(73) Assignee: SEIKO EPSON CORPORATION, Tokyo (JP)

(21) Appl. No.: 13/612,086

(22) Filed: Sep. 12, 2012

(30) Foreign Application Priority Data
Sep. 14, 2011 (JP) 2011-200428

(51) Int. Cl. H02K 1/12; H02K 15/00

(52) U.S. Cl. 310/216.004; 29/596

(57) ABSTRACT

A coil back yoke has laminated structure in which a plurality of annular components are stuck together along the axis direction of a cylinder, the annular component is formed of a soft magnetic body and has structure in which a plurality of divided annular components having a shape divided along the circumferential direction of an annular ring are stuck together in an annular shape, and, to prevent joint portions formed in the annular components by sticking together the divided annular components along the circumferential direction of the annular ring from lining up on a straight line parallel to the axis direction of the cylinder, the joint portions of at least a part of the plurality of annular components are stuck together while being shifted along the circumferential direction of the annular ring with respect to the joint portions of the other annular components.

### BACKGROUND

1. Technical Field

The present invention relates to a coil back yoke used in a coreless electromechanical device.

2. Related Art

In a coreless dynamo-electric machine (in this specification, also referred to as “electromechanical device”) such as electric motor or generator, a plurality of air-core electromagnetic coils are arranged in a cylindrical shape on the outer circumferential side or the inner circumferential side of a rotor to be opposed to permanent magnets arranged in a cylindrical shape along the inner circumference or the outer circumference of the rotor. A cylindrical coil back yoke is arranged on the outer circumferential side or the inner circumferential side of the electromagnetic coils, i.e., the opposite side of the permanent magnets with respect to the electromagnetic coils. With the coil back yoke, it is possible to suppress occurrence of leak magnetic fluxes from the permanent magnets to further outer circumference or the inner circumference than the coil back yoke, increase the density of magnetic fluxes effectively interlinked with the electromagnetic coils, and improve conversion efficiency of the electromechanical device.

The coil back yoke can be manufactured by punching, with a die, an electromagnetic steel plate material (also referred to as “steel plate material”), which is a soft magnetic material such as a silicon steel plate, to manufacture an annular coil back yoke component (also referred to as “annular component”), laminating a plurality of the manufactured annular components to integrally form the annular components. Alternatively, the cylindrical coil back yoke can be manufactured by punching, with a die, a laminated steel plate material obtained by laminating a plurality of steel plate materials. However, in the case of these manufacturing methods, for example, a portion of the steel plate materials corresponding to a hollow section of an annular ring or a portion of the laminated steel plate material corresponding to a hollow section of a cylinder is a scrap material. Therefore, improvement is desired in terms of manufacturing costs.

Concerning the problem, the wasteful scrap material can be reduced by sticking together a plurality of divided annular components to form an annular component or sticking together a plurality of divided cylindrical components to form a coil back yoke. Therefore, it is possible to reduce manufacturing costs. However, when the divided components are stuck together, so-called cogging is conspicuous. This is considered to be because, since magnetic poles are formed in portions where the divided annular components or the divided cylindrical components are stuck together (also referred to as “joint portions”), attraction or repulsion occurs between the magnetic poles of the permanent magnets and the magnetic poles in the joint portions and so-called cogging occurs. This also considered to be because, since magnetic resistance increases in the joint portions and the magnetic resistance changes according to the position of the coil back yoke, dependency occurs in magnetic resistance in a magnetic circuit formed by the permanent magnets and the coil back yoke and so-called cogging occurs. In any case, cogging occurs because of the presence of the joint portions in the coil back yoke.

Since the magnetic resistance increases in the joint portions, magnetic flux density on the permanent magnet surface of magnetic fluxes between the permanent magnets and the coil back yoke falls. Further, an eddy current loss increases according to the number of revolutions of the rotor because of leak magnetic fluxes from the joint portions.

Examples of the related art include JP-A-2003-235185 and JP-A-2003-324865.

### SUMMARY

An advantage of some aspects of the invention is to provide a technique that can suppress occurrence of cogging.

### Application Example 1

This application example of the invention is directed to a cylindrical coil back yoke arranged, in a careless electromechanical device including a rotor and a stator, in the inner circumference or the outer circumference of air-core electromagnetic coils arranged along the cylindrical surface in the stator, wherein the cylindrical coil back yoke has laminated structure in which a plurality of annular components are stuck together along the axis direction of a cylinder, the annular component is formed of a soft magnetic body and has structure in which a plurality of divided annular components having a shape divided along the circumferential direction of an annular ring are stuck together in an annular shape, and, to prevent joint portions formed in the annular components by sticking together the divided annular components along the circumferential direction of the annular ring from lining up on a straight line parallel to the axis direction of the cylinder, the joint portions of at least apart of the plurality of annular components are stuck together while being shifted along the circumferential direction of the annular ring with respect to the joint portions of the other annular components.

The magnitude of cogging torque that occurs in the coreless electromechanical device because of the presence of the joint portions of the coil back yoke is considered to be integration of cogging torque caused by the joints of the annular components lining up on a straight line parallel to a direction coinciding with an axis of rotation, i.e., the axis direction of the cylinder of the coil back yoke. In the coil back yoke, the joint portions of the laminated annular components can be dispersed not to line up on a straight line parallel to the axis direction of the cylinder. Therefore, when the coil back yoke is applied to the coreless electromechanical device, it is possible to suppress occurrence of cogging.

### Application Example 2

This application example of the invention is directed to the coil back yoke of Application Example 1, wherein the annular components are stuck together with the joint portions shifted in the order of the lamination along the circumferential direction of the annular ring.

In the coil back yoke of this application example, the joint portions of the laminated annular components are most effectively dispersed while being arranged to be shifted from one another not to line up on a straight line parallel to the axis direction of the cylinder. Therefore, when the coil back yoke is applied to the coreless electromechanical device, it is possible to most effectively suppress occurrence of cogging because of the presence of the joint portions.

### Application Example 3

This application example of the invention is directed to the coil back yoke of Application Example 1 or 2, wherein the joint portions where the divided annular components are stuck together include joining sections formed by a joining member including powder of a soft magnetic body.

In the coil back yoke of this application example, magnetic discontinuity in the joint portions is relaxed by the soft magnetic body included in the joining sections. Consequently, when the coil back yoke is applied to the coreless electromechanical device, it is possible to reduce leak magnetic fluxes from the joint portions. Therefore, it is possible to suppress an eddy current loss caused by the leak magnetic fluxes. Further, it is possible to reduce magnetic resistance of the joint portions. Therefore, it is possible to suppress a fall in a magnetic flux density on the permanent magnet surface of magnetic fluxes between permanent magnets arranged on the rotor of the coreless electromechanical device and the coil back yoke.

### Application Example 4

This application example of the invention is directed to a coreless electromechanical device including a rotor and a stator, wherein the rotor includes permanent magnets arranged along the cylindrical surface in the rotor, the stator includes air-core electromagnetic coils arranged along the cylindrical surface in the stator to be opposed to the permanent magnets and a coil back yoke arranged to be opposed to the permanent magnets across the air-core electromagnetic coils, and the coil back yoke is the coil back yoke of any of Application Examples 1 to 3.

Since the coreless electromechanical device of this application example includes the coil back yoke of any of Application Examples 1 to 3, it is possible to suppress occurrence of cogging while realizing a reduction in manufacturing costs.

### Application Example 5

This application example of the invention is directed to a mobile body including the coreless electromechanical device of Application Example 4.

### Application Example 6

This application example of the invention is directed to a robot including the coreless electromechanical device of Application Example 4.

### Application Example 7

This application example of the invention is directed to a method of manufacturing a cylindrical coil back yoke arranged, in a coreless electromechanical device including a rotor and a stator, in the inner circumference or the outer circumference of air-core electromagnetic coils arranged along the cylindrical surface in the stator, the cylindrical coil back yoke having laminated structure in which a plurality of annular components are stuck together along the axis direction of a cylinder, the method including: punching, from a steel plate material, which is a soft magnetic body, divided annular components having a shape equally divided along the circumferential direction of an annular ring of the annular components; and sticking together the divided annular components along the circumferential direction of the annular ring to form one annular component and, while sticking together the divided annular components over the upper surface in the axis direction side of the annular ring of the formed one annular component, sticking together the divided annular components along the circumferential direction of the annular ring to form the next one annular component to thereby form laminated structure in which the plurality of annular components are stuck together along the axis direction of the cylinder, wherein the forming of the laminated structure includes, to prevent joint portions formed in the annular components by sticking together the divided annular components along the circumferential direction of the annular ring from lining up on a straight line parallel to the axis direction of the cylinder, sticking together the divided annular components corresponding to at least a part of the plurality of annular components while shifting the divided annular components along the circumferential direction of the annular ring.

With the method of manufacturing the coil back yoke of this application example, it is possible to provide a coil back yoke capable of suppressing occurrence of cogging while realizing a reduction in manufacturing costs.

### Application Example 8

This application example of the invention is directed to a method of manufacturing a cylindrical coil back yoke arranged, in a coreless electromechanical device including a rotor and a stator, in the inner circumference or the outer circumference of air-core electromagnetic coils arranged along the cylindrical surface in the stator, the cylindrical coil back yoke having laminated structure in which a plurality of annular components are stuck together along the axis direction of a cylinder, the method including: punching, from a steel plate material, which is a soft magnetic body, divided annular components having a shape equally divided along the circumferential direction of an annular ring of the annular components; forming a plurality of divided cylindrical components formed by sticking together a plurality of the divided annular components along the axis direction of the cylinder; and sticking together the formed plurality of divided cylindrical components to thereby form laminated structure in which the plurality of annular components are stuck together along the axis direction of the cylinder, wherein the forming of a plurality of divided cylindrical components includes, to prevent joint portions formed in the annular components by sticking together the divided annular components along the circumferential direction of the annular ring in the forming the laminated structure from lining up on a straight line parallel to the axis direction of the cylinder, sticking together the divided annular components corresponding to at least a part of the plurality of annular components while shifting the divided annular components along the circumferential direction of the annular ring.

In the method of manufacturing the coil back yoke of this application example, as in the method explained above, it is possible to provide a coil back yoke capable of suppressing occurrence of cogging while realizing a reduction in manufacturing costs.

The invention can be implemented in various forms. For example, besides the coil back yoke and the method of manufacturing the coil back yoke, it is possible to implement the invention in various forms including a coreless electromechanical device such as an electric motor or a generator including the coil back yoke and a mobile body, a robot, or a medical apparatus including the coreless electromechanical device.

### BRIEF DESCRIPTION OF THE DRAWINGS

The invention will be described with reference to the accompanying drawings, wherein like numbers reference like elements.

FIGS. 1A and 1B are explanatory diagrams showing a coreless motor according to a first embodiment.

FIGS. 2A to 2C are explanatory diagrams schematically showing a cross section of the coreless motor according to the first embodiment taken along a cutting line perpendicular to a rotating shaft.

FIGS. 3A and 3B are explanatory diagrams showing an arrangement state of electromagnetic coils.

FIG. 4 is an explanatory diagram showing a schematic assembly procedure for the coreless motor.

FIGS. 5A and 5B are explanatory diagrams showing a coil back yoke in enlargement.

FIGS. 6A and 6B are explanatory diagrams showing a manufacturing procedure for the coil back yoke.

FIG. 7 is an explanatory diagram showing the manufacturing process for the coil back yoke.

FIG. 8 is an explanatory diagram showing cogging torque characteristics in the case of the coil back yoke according to the embodiment, a reference coil back yoke, and a coil back yoke in a comparative example 1 in comparison with one another.

FIG. 9 is an explanatory diagram showing surface magnetic flux density characteristics of permanent magnets in the case of the coil back yoke according to the embodiment, the reference coil back yoke, and a coil back yoke in a comparative example 2 in comparison with one another.

FIG. 10 is an explanatory diagram showing eddy current loss characteristics of the coil back yoke according to the embodiment, the reference coil back yoke, and the coil back yoke in a comparative example 2 in comparison with one another.

FIG. 11 is an explanatory diagram showing another manufacturing procedure for the coil back yoke.

FIGS. 12A to 12D are explanatory diagrams schematically showing an expanded plane of a cylindrical surface of a coil back yoke in a modification.

FIGS. 13A and 13B are explanatory diagrams showing a coreless motor according to a second embodiment.

FIG. 14 is an explanatory diagram showing an electric bicycle (an electrically assisted bicycle), which is an example of a mobile body in which a coreless motor having characteristics of the invention is used.

FIG. 15 is an explanatory diagram showing an example of a robot in which a coreless motor having the characteristics of the invention is used.

FIG. 16 is an explanatory diagram showing an example of a double-arm 7-axis robot in which a coreless motor having the characteristics of the invention is used.

FIG. 17 is an explanatory diagram showing a railway vehicle in which a coreless motor having the characteristics of the invention is used.

### DESCRIPTION OF EXEMPLARY EMBODIMENTS

### First Embodiment

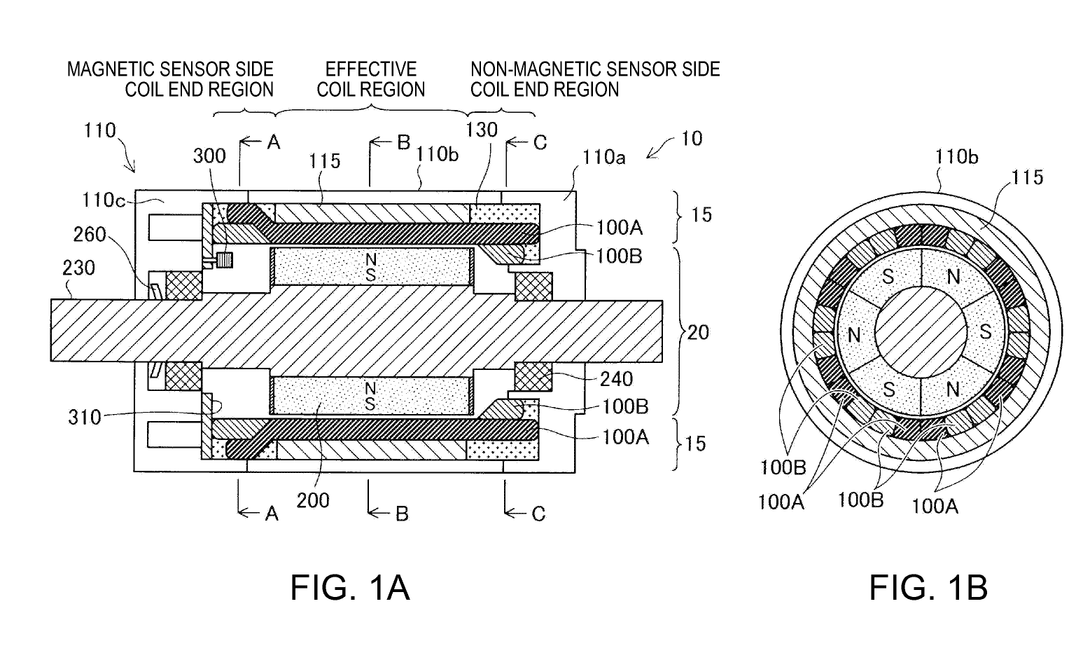

FIGS. 1A and 1B are explanatory diagrams showing a coreless motor 10 according to a first embodiment. FIG. 1A schematically shows a diagram of a schematic cross section of the coreless motor 10 taken along a surface parallel to a rotating shaft 230 and viewed from a direction perpendicular to the cross section. FIG. 1B schematically shows a diagram of a schematic cross section of the coreless motor 10 taken along a cutting line (B-B in FIG. 1A) perpendicular to the rotating shaft 230 and viewed from a direction perpendicular to the cross section.

The coreless motor 10 is an inner rotor type motor having a radial gap structure in which a substantially cylindrical stator 15 is arranged on the outer side and a substantially cylindrical rotor 20 is arranged on the inner side. The stator 15 includes a coil back yoke 115 arranged along the inner circumference of a substantially cylindrical casing portion 110b of a casing 110 and plural electromagnetic coils 100A and 100B arrayed on the inner side of the coil back yoke 115. In this embodiment, when the two-phase electromagnetic coils 100A and 100B are not distinguished, the electromagnetic coils 100A and 100B are simply referred to as electromagnetic coils 100. The coil back yoke 115 is formed of a soft magnetic material and formed in a substantially cylindrical shape. The electromagnetic coils 100A and 100B are molded with resin 130.

The length of the electromagnetic coils 100A and 100B along the rotating shaft 230 is larger than the length of the coil back yoke 115 along the rotating shaft 230. In other words, in FIG. 1A, ends in the left right direction of the electromagnetic coils 100A and 100B do not overlap the coil back yoke 115. In this embodiment, regions overlapping the coil back yoke 115 are referred to as effective coil regions. Regions not overlapping the coil back yoke 115 are referred to as coil end regions. In this embodiment, the effective coil regions of the electromagnetic coils 100A and 100B are arranged in a cylindrical region along the same cylindrical surface. However, concerning the coil end regions, as explained below, one of two coil end regions is bent from the cylindrical region to the outer circumferential side or the inner circumferential side. For example, concerning the electromagnetic coil 100A, as shown in FIG. 1A, the coil end region on the right side is arranged in the cylindrical region and is not bent. However, the coil end region on the left side is bent from the cylindrical region to the outer circumferential side. Concerning the electromagnetic coil 100B, as shown in FIG. 1A, the coil end region on the left side is arranged in the cylindrical region and is not bent. However, the coil end region on the right side is bent from the cylindrical region to the inner circumferential side. The electromagnetic coils 100A and 100B may have structure in which the shapes of the coil end regions thereof are interchanged.

On a side surface on a side along the rotating shaft 230 of the stator 15 (the left side in the figure), a magnetic sensor 300 functioning as a position sensor that detects the phase of the rotor 20 is arranged. As the magnetic sensor 300, for example, a Hall sensor configured by a Hall IC including a Hall element can be used. The magnetic sensor 300 generates a substantially sine-wave sensor signal according to driving control of an electric angle. The sensor signal is used for generating a driving signal for driving the electromagnetic coil 100. Therefore, one magnetic sensor 300 is desirably provided in each of the two-phase electromagnetic coils 100A and 100B. The magnetic sensor 300 is fixed on a circuit board 310. The circuit board 310 is fixed to a casing portion 110c of the casing 110. In this embodiment, the magnetic sensor 300 and the circuit board 310 are arranged on the left side of FIG. 1A. In this embodiment, using a positional relation between the magnetic sensor 300 and the coil end regions, the coil end region close to the magnetic sensor 300 (the coil end region on the left side of FIG. 1A) of the two coil end regions is referred to as “magnetic sensor side coil end region” and the coil end region far from the magnetic sensor 300 (the coil end region on the right side of FIG. 1A) is referred to as “non-magnetic sensor side coil end region”.

The rotor 20 includes the rotating shaft 230 in the center and includes plural permanent magnets 200 in the outer circumference of the rotating shaft 230. The permanent magnets 200 are magnetized along a radial direction (a radiation direction) from the center of the rotating shaft 230 to the outside. The characters N and S affixed to the permanent magnets 200 in FIG. 1B indicate the polarities of the permanent magnets 200 on the electromagnetic coils 100A and 100B side on the magnet surfaces in the outer circumference. The permanent magnets 200 and the electromagnetic coils 100 are arranged to be opposed to opposed cylindrical surfaces of the rotor 20 and the stator 15. The length of the permanent magnet 200 in the direction along the rotating shaft 230 is the same as the length of the coil back yoke 115 in the direction along the rotating shaft 230. In other words, regions where a region between the permanent magnet 200 and the coil back yoke 115 and the electromagnetic coil 100A or the electromagnetic coil 100B overlap are the effective coil regions. The rotating shaft 230 is supported by a bearing 240 of the casing 110. When the rotating shaft 230 is a nonmagnetic body such as resin (e.g., a CFRP material), a magnet back yoke may be provided between the permanent magnet 200 and the rotating shaft 230. Side yokes may be provided at both ends of the permanent magnet 200 in the direction along the rotating shaft 230. A magnetic flux can be easily closed by using the magnet back yoke or the side yokes. In this embodiment, a wave spring metal washer 260 is provided on the inner side of the casing 110. The wave spring metal washer 260 positions the permanent magnet 200. However, the wave spring metal washer 260 can be replaced with another component.

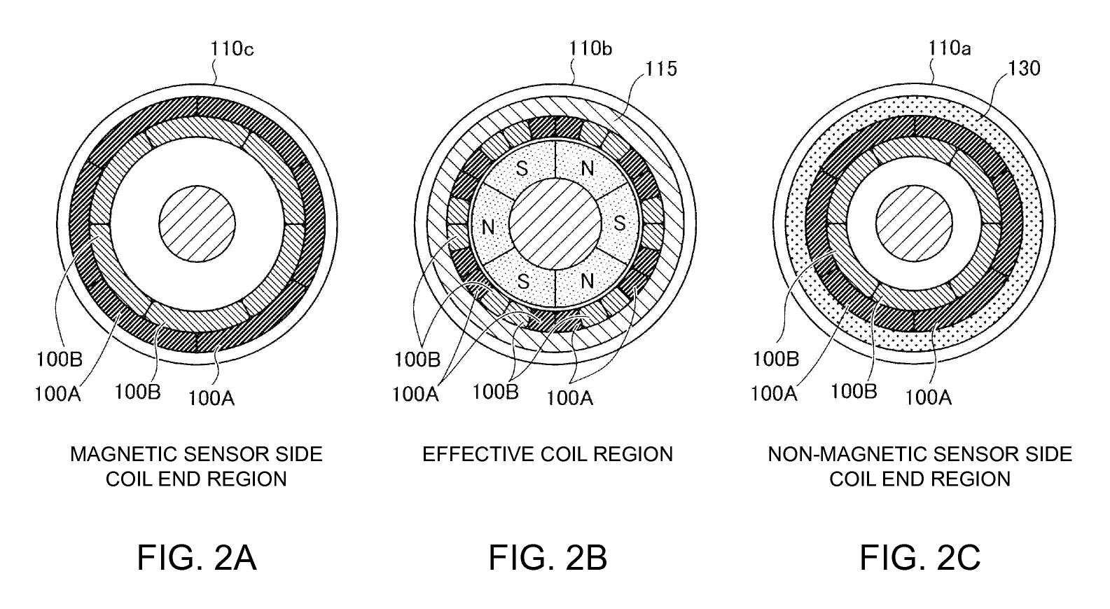

FIGS. 2A to 2C are explanatory diagrams schematically showing a cross section of the coreless motor 10 according to the first embodiment taken along a cutting line perpendicular to the rotating shaft 230. FIG. 2A shows a schematic cross section of the magnetic sensor side coil end region of the electromagnetic coils 100A and 100B taken along an A-A cutting line perpendicular to the rotating shaft 230 shown in FIG. 1A. FIG. 2B shows a schematic cross section of the effective coil region of the electromagnetic coils 100A and 100B taken along a B-B cutting line perpendicular to the rotating shaft 230 shown in FIG. 1A. FIG. 2C shows a schematic cross section of the non-magnetic sensor side coil end region of the electromagnetic coils 100A and 100B taken along a C-C cutting line perpendicular to the rotating shaft 230 shown in FIG. 1A. FIG. 2B is a drawing same as FIG. 1B.

As shown in FIG. 2B, in the cross section perpendicular to the rotating shaft 230 in the effective coil regions of the electromagnetic coils 100A and 100B (the cross section taken along the B-B cutting line in FIG. 1A), the effective coil regions of the electromagnetic coils 100A and 100B are arranged in the same cylindrical region. On the other hand, in the cross section perpendicular to the rotating shaft 230 in the magnetic sensor side coil end region shown in FIG. 2A, the coil end region of the electromagnetic coil 100B is arranged in the cylindrical region same as the cylindrical region where the effective coil region of the electromagnetic coil 100B is arranged in FIG. 2B. However, the coil end region of the electromagnetic coil 100A is arranged further on the outer circumferential side (the coil back yoke 115 side) than the cylindrical region where the effective coil region of the electromagnetic coil 100A is arranged. In the cross section perpendicular to the rotating shaft 230 in the non-magnetic sensor side coil end region shown in FIG. 2C, the coil end region of the electromagnetic coil 100A is arranged in the cylindrical region same as the cylindrical region where the effective coil region of the electromagnetic coil 100A is arranged in FIG. 2B. However, the coil end region of the electromagnetic coil 100B is arranged further on the inner circumferential side (the permanent magnet 200 side) than the cylindrical region where the effective coil region of the electromagnetic coil 100B is arranged.

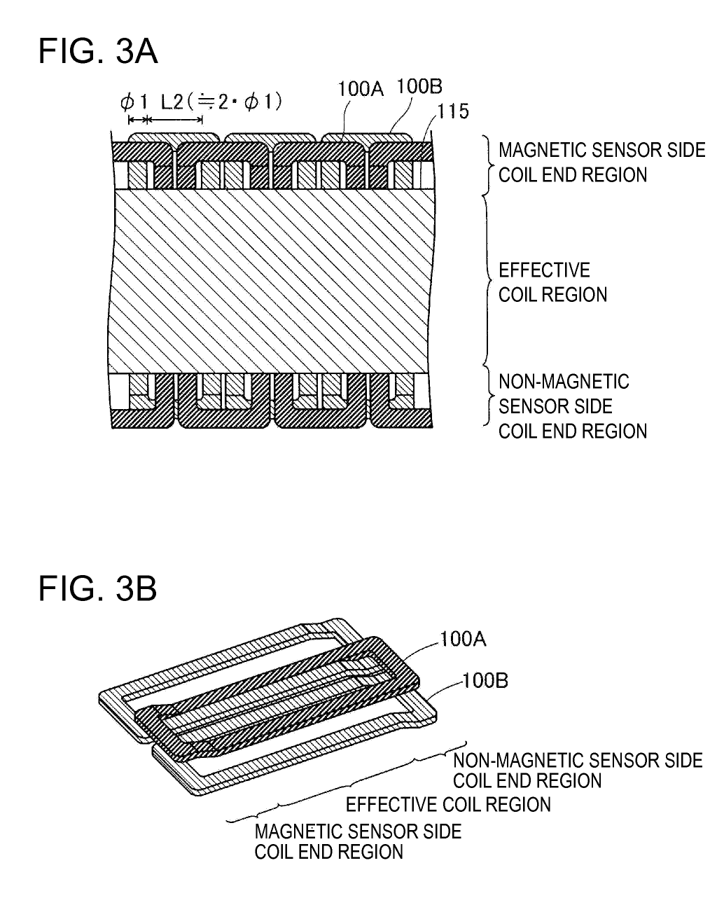

FIGS. 3A and 3B are explanatory diagrams showing an arrangement state of the electromagnetic coils 100A and 100B. FIG. 3A is a plan view of the electromagnetic coils 100A and 100B viewed from the coil back yoke 115 side. FIG. 3B is a perspective view schematically showing the electromagnetic coils 100A and 100B. In FIG. 3A, the coil back yoke 115 is shown. In FIG. 3B, to clearly show the shapes of the electromagnetic coils 100A and 100B, the coil back yoke 115 is not shown and only one electromagnetic coil 100A and two electromagnetic coils 100B are shown. Actual electromagnetic coils 100A and 100B are arranged along a side surface of a cylinder. However, in FIG. 3B, the electromagnetic coils 100A and 100B are schematically shown as a plane.

Bundles of conductors in the effective coil region of the two electromagnetic coils 100B are fit in between two bundles of conductors of the effective coil region of the electromagnetic coil 100A. The electromagnetic coils 100 are formed by winding conductors in plural turns. A bundle of conductors (hereinafter also referred to as “coil bundle”) means a bundle of plural conductors. Coil bundles in the effective coil region of the two electromagnetic coils 100A are fit in between two coil bundles in the effective coil region of the electromagnetic coil 100B. The electromagnetic coil 100A and the electromagnetic coil 100B do not interfere with each other. The magnetic sensor side coil end region of the electromagnetic coil 100A is bent from the cylindrical region to the coil back yoke 115 side (the outer circumferential side of the cylindrical region). The magnetic sensor side coil end region of the electromagnetic coil 100A does not interfere with the magnetic sensor side coil end region of the electromagnetic coil 100B. The non-magnetic sensor side coil end region of the electromagnetic coil 100B is bent from the cylindrical region to the opposite side of the coil back yoke 115 (the inner circumferential side of the cylindrical region). The non-magnetic sensor side coil end region of the electromagnetic coil 100B does not interfere with the non-magnetic sensor side coil end region of the electromagnetic coil 100A. In this way, the effective coil region of the electromagnetic coil 100A and the effective coil region of the electromagnetic coil 100B are arranged not to interfere with each other on the same cylindrical region. The magnetic sensor side coil end region of the electromagnetic coil 100A is bent to the outer circumferential side and the non-magnetic sensor side coil end region of the electromagnetic coil 100B is bent to the inner circumferential side. Consequently, it is possible to suppress interference of the electromagnetic coil 100A and the electromagnetic coil 100B.

In this embodiment, thickness φ1 of the coil bundles of the electromagnetic coils 100A and 100B (thickness in a direction along the cylindrical region where the effective coil region of the electromagnetic coil 100A is arranged) and a space L2 of the coil bundles in the effective coil region (a space in the direction along the cylindrical region where the effective coil region of the electromagnetic coil 100A is arranged) have a relation L2≈2×φ1. In other words, the cylindrical region where the electromagnetic coils 100A and 100B are arranged is nearly occupied by the coil bundles of the electromagnetic coils 100A and 100B. Therefore, it is possible to improve a space factor of the electromagnetic coils and improve efficiency of the coreless motor 10 (FIG. 1A).

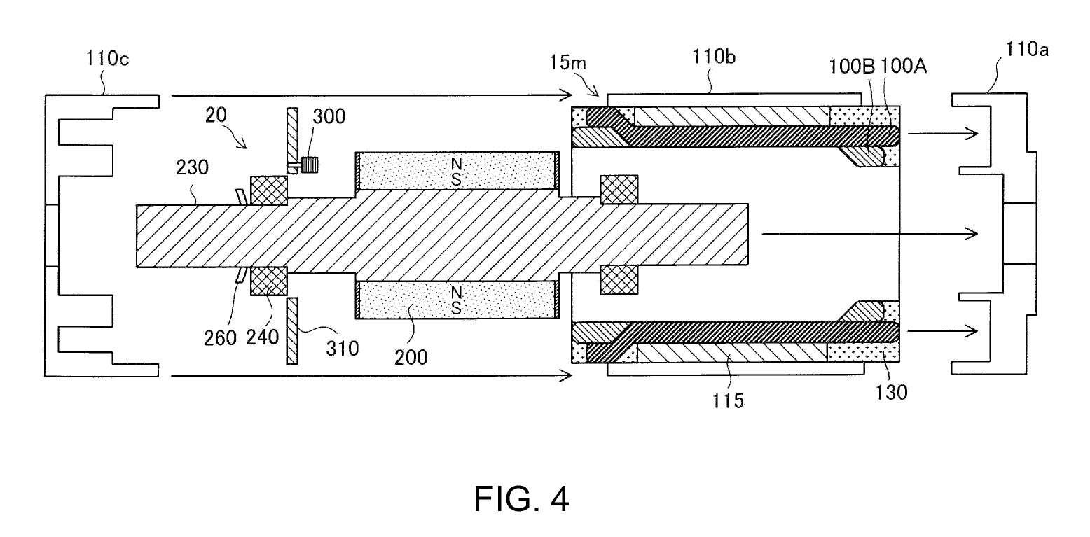

FIG. 4 is an explanatory diagram showing a schematic assembly procedure for the coreless motor 10. First, to attach a stator module 15m arranged in the inner circumference of the second casing portion 110b to the first casing portion 110a, the second casing portion 110b and the stator module 15m are assembled to the first casing portion 110a. The stator module 15m is configured by inserting the coil back yoke 115 into the outer circumference of the electromagnetic coils 100A and 100B arranged along the cylindrical surface from the first casing portion 110a side in FIG. 4 and molding the coil back yoke 115 with the resin 130. Subsequently, to attach one bearing 240 of the rotor 20 to the first casing portion 110a, the rotor 20 including the circuit board 300 is assembled to the first casing portion 110a. To attach the other bearing 240, which is attached to the rotor 20, and the circuit board 310 to the third casing portion 110c, the third casing portion 110c is assembled to the second casing portion 110b. Consequently, the coreless motor 10 is assembled.

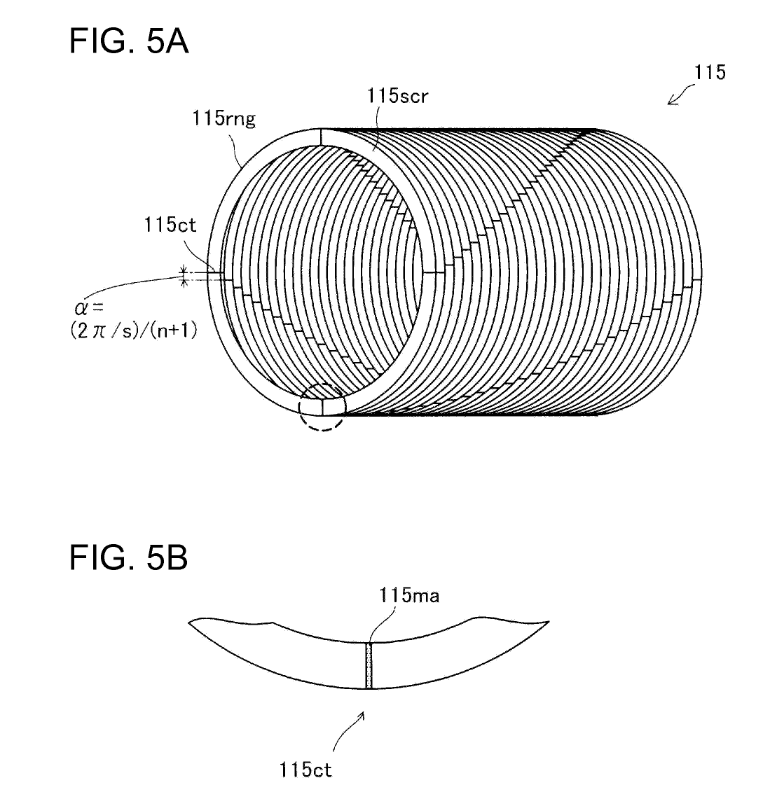

FIGS. 5A and 5B are explanatory diagrams showing the coil back yoke 115 in enlargement. FIG. 5A shows a schematic perspective view of the coil back yoke 115. FIG. 5B is a schematic plan view showing a portion surrounded by a broken line circuit in FIG. 5A in enlargement. As shown in FIG. 5A, the coil back yoke 115 has a substantially cylindrical shape and has laminated structure in which plural annular components 115rng are stuck together along the axis direction of a cylinder. In this embodiment, it is assumed that two hundred and thirty annular components 115rng, the thickness in the axis direction of the cylinder of which is 100 μm, are laminated. However, in FIG. 5A, to clearly show the figure, only thirty annular components 115rng are shown. The number of laminated annular components is an example and is set according to the thickness of a steel plate in use and the dimensions of a coil back yoke.

The annular component 115rng has structure in which divided annular components 115scr having a shape obtained by dividing the annular component 115rng into four along the circumferential direction of an annular ring are stuck together along the circumferential direction of the annular ring. The divided annular component 115scr is formed of a soft magnetic body material such as a general silicon steel plate material (Si=3.5%), a JNEX/JNHF material (Si=6.5%) manufactured by JFE Steel Corporation, or an amorphous material. In this example, it is assumed that the divided annular component 115scr is formed by punching the general silicon steel plate material with a die. The number of divided annular components is an example and is set according to the dimensions of a coil back yoke, the dimensions of a steel plate material used as a material of the coil back yoke, the number of annular components per one steel plate material.

In a joint portion 115ct where the divided annular components 115scr are stuck together along the circumferential direction of the annular ring, as shown in FIG. 5B, a joining section 115ma is formed by hardening a joining member such as an adhesive used for sticking together the divided annular components 115scr. The joining member is obtained by mixing or kneading powder of a soft magnetic body such as silicon (Si) or an amorphous magnetic body in a bonding and joining member including resin, rubber, or the like. The joining section 115ma is formed by heating and hardening the joining member. In this example, a magnetic adhesive obtained by mixing powder of silicon, which is the soft magnetic body, in thermosetting resin, which is the bonding and joining member, is used as the joining member.

The annular components 115rng are stuck together while being shifted in the order of lamination along the circumferential direction of the annular ring by being rotated in the order of lamination around the axis of the cylinder as shown in FIG. 5A to prevent the joint portions 115ct of the annular components 115rng from lining up on a straight line parallel to the axis direction of the cylinder. An amount of shift of the annular components 115rng stuck together can be represented by an angle about the axis of the cylinder or the length in the circumferential direction. For example, an amount of shift α [rad] represented by the angle about the axis of the cylinder is represented as α=(2π/s)/(n+1) using the number s of the divided annular components 115rng and the number of stuck-together (laminated) annular components 115rng. As in this example, in the case of s=4 and n=230, the amount of shift α is 2π/231 [rad]. In other words, the annular components 115rng are stuck together in a state in which the joint portions 115ct of the annular components 115rng stuck together are rotated and shifted in the circumferential direction of the annular ring by the amount of shift α=2π/231 [rad].

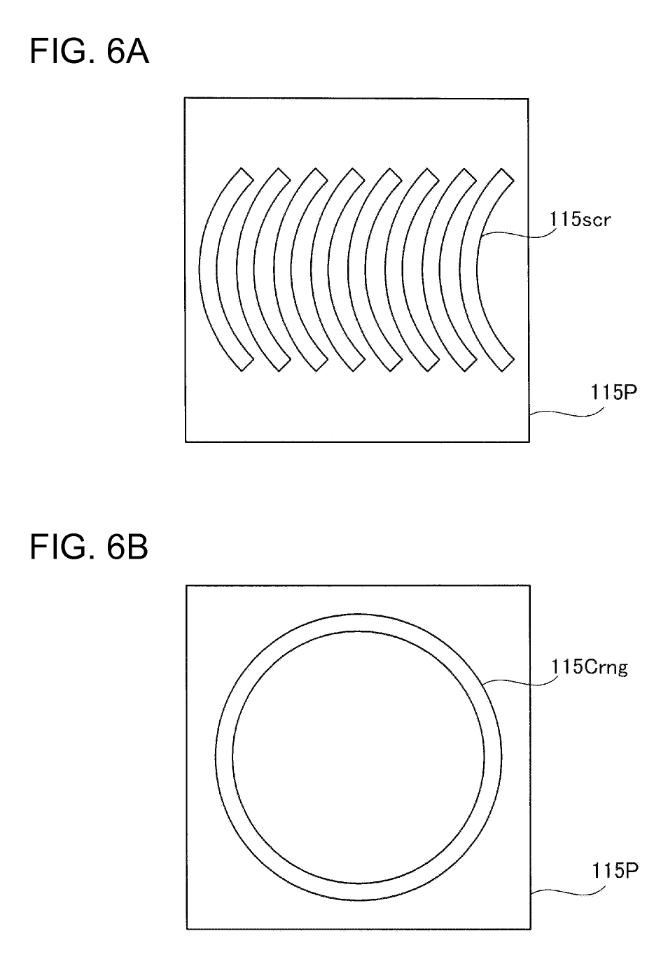

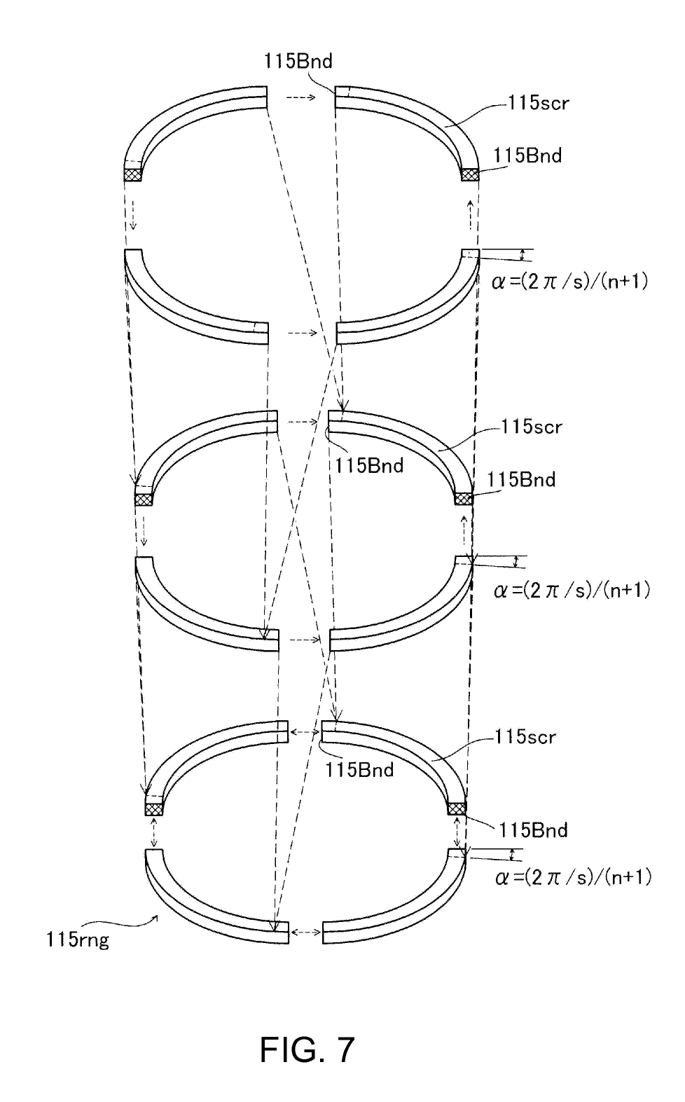

The coil back yoke 115 can be easily manufactured by a manufacturing procedure explained below. FIGS. 6A and 6B and FIG. 7 are explanatory diagrams showing the manufacturing procedure for the coil back yoke 115. First, steel plate materials 115P are prepared by a number necessary for forming a necessary number of divided annular components 115scr. The steel plate material 115P is a steel plate material obtained by applying an insulating adhesive to at least one surface of a general silicon steel plate. As shown in FIG. 6A, the divided annular components 115scr are punched from the steel plate material 115P by a die. Eight divided annular components 115scr equivalent to two annular components 115rng can be formed per one steel plate material 115P. On the other hand, as shown in FIG. 6B as a comparative example, when an annular component 115Crng equivalent to one annular component 115rng including four divided annular components is punched from the steel plate material 115P by a die, only one annular component 115Crng can be formed from the same one steel plate material 115P. Therefore, in the case of this embodiment, a waste of members for manufacturing annular components can be reduced. As explained above, if the coil back yoke 115 has the laminated structure in which the two hundred and thirty annular components 115rng are stuck together, it is necessary to prepare at least one hundred and fifteen steel plate materials 115P.

Subsequently, as shown in FIG. 7, first, four divided annular components 115scr are stuck together along the circumferential direction of the annular ring to form the annular component 115rng in the first layer. The divided annular components 115scr are stuck together after a magnetic adhesive 115Bnd, which is a joining member, is applied to at least one of surfaces to be stuck together of the divided annular components 115scr. The four divided annular components 115scr are stuck together along the circumferential direction of the annular ring while being stuck to one surface on the axis (axis of the cylinder of the coil back yoke 115) direction side of the annular ring of the annular component 115rng in the first layer to form the annular component 115rng in the second layer. Further, the four divided annular components 115scr are stuck together along the circumferential direction of the annular ring while being stuck to one surface on the axis direction side of the annular ring of the annular component 115rng in the second layer to form the annular component 115rng in the third layer. Thereafter, the two hundred and thirty annular components 115rng are stuck together along the axis direction of the cylinder in the same manner. However, the annular components 115rng are arranged and stuck together such that an end of the divided annular components 115scr of the annular component on the upper layer side is rotated and shifted in the circumferential direction of the annular ring by the amount of shift α with respect to an end of the divided annular components 115scr of the annular component 115rng on the adjacent lower layer side (equivalent to the joint portion 115ct shown in FIGS. 5A and 5B).

Finally, a laminated body of the formed annular components 115rng is heated to harden the insulating adhesive among the annular components 115rng and the magnetic adhesive 115Bnd among the divided annular components 115scr. According to the procedure explained above, the coil back yoke 115 shown in FIG. 5A is formed.

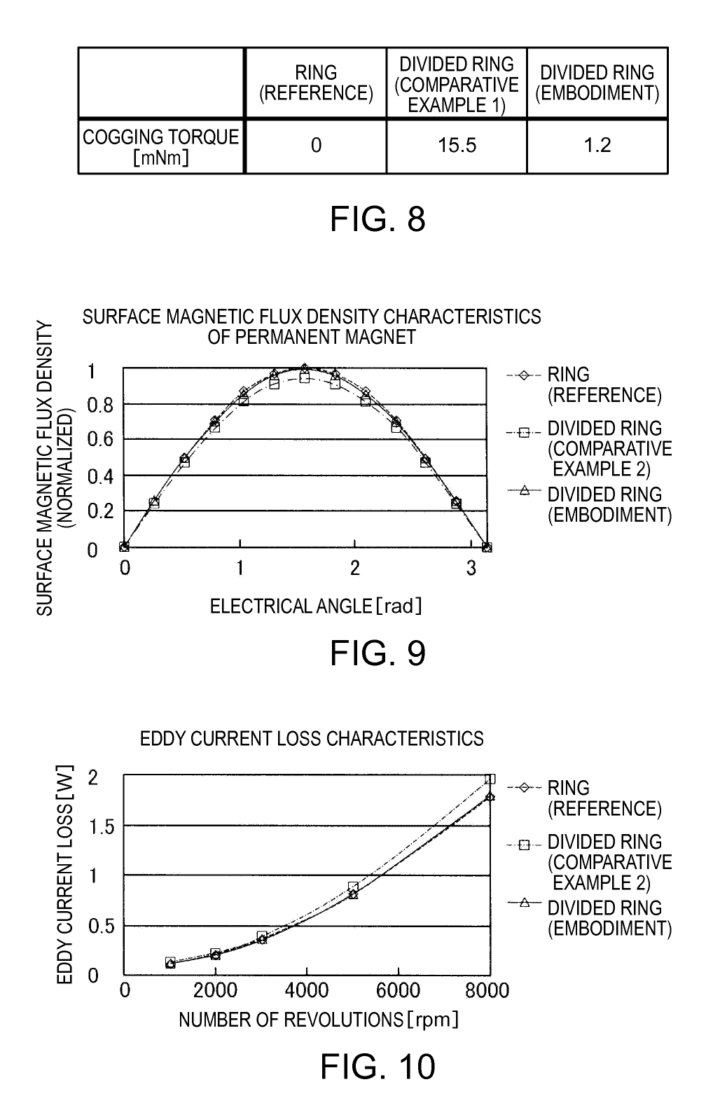

FIG. 8 is an explanatory diagram showing cogging torque characteristics in the case of the coil back yoke according to this embodiment, a reference coil back yoke, and a coil back yoke in a comparative example 1 in comparison with one another. The reference coil back yoke (in FIG. 8, written as “ring (reference)”) is a coil back yoke formed by sticking together undivided annular components. The coil back yoke in the comparative example 1 (in FIG. 8, written as “divided ring (comparative example 1)”) is a coil back yoke formed by sticking together annular components, which are formed by sticking together divided annular components, such that joint portions line up on a straight line parallel to the axis direction of a cylinder. Measurement of cogging torque was performed by connecting motors to be measured, in which the coil back yokes are respectively used, to a rotation torque meter, in this example, N2400-SGK(I) manufactured by Nakamura Mfg. Co., Ltd.

As shown in FIG. 8, in the case of the reference, since there is no joint portion, cogging torque was not measured. On the other hand, in the case of the comparative example 1, extremely large cogging torque of 15.5 [mNm] was measured. In the case of this embodiment, extremely small cogging torque of 1.2 [mNm] was measured. It can be said that, in the case of this embodiment, occurrence of cogging is suppressed, although the coil back yoke is formed using the annular components formed by sticking together the divided annular components as in the comparative example 1. In the case of a coil back yoke in which, although annular components formed by sticking together divided annular components are arranged with joint portions thereof shifted in order as in this embodiment, the divided annular components are stuck together by a normal insulating adhesive rather than the magnetic adhesive (not shown in the figure), a measurement value of cogging torque is substantially the same as that of this embodiment.

When the annular components 115rng formed by sticking together the divided annular components 115scr arranged with the joint portions 115ct thereof shifted as in this embodiment, occurrence of cogging can be suppressed. This is considered to be because of reasons explained below. The magnitude of cogging torque that occurs in a coreless motor because of the presence of the joint portions of the coil back yoke is considered to be integration of cogging torque caused by the joint portions of the annular components lining up on a straight line parallel to a direction coinciding with an axis of rotation, i.e., the axis direction of the cylinder of the coil back yoke. In the case of the comparative example 1, the extremely large cogging torque is considered to occur because the joint portions line up on a straight line parallel to the axis direction of the cylinder. On the other hand, in the coil back yoke 115 according to this embodiment, occurrence of cogging is considered to have been able to be suppressed because the joint portions 115ct of the annular components 115rng are arranged and dispersed be shifted in order not to line up on a straight line parallel to the axis direction of the cylinder.

FIG. 9 is an explanatory diagram showing surface magnetic flux density characteristics of permanent magnets in the case of the coil back yoke according to this embodiment, the reference coil back yoke, and a coil back yoke in a comparative example 2 in comparison with one another. The coil back yoke in the comparative example 2 (in FIG. 9, written as “divided ring (comparative example 2)”) is a coil back yoke in which, although annular components formed by sticking together divided annular components are arranged with joint portions thereof shifted as in this embodiment, the divided annular components are stuck together by a normal insulating adhesive rather than the magnetic adhesive. In FIG. 9, a position along a rotating direction of a permanent magnet of one pole is represented by an electrical angle 0 to π [rad]. Surface magnetic flux density characteristics obtained by measuring a surface magnetic flux density with respect to the electrical angle using a standard magnetic flux density meter are shown. Surface magnetic flux density characteristics in this embodiment and the comparative example 2 are shown while being normalized with reference to reference surface magnetic flux density characteristics.

As shown in FIG. 9, in the case of the comparative example 2, the surface magnetic flux density falls about maximum 5% compared with the case of the reference. Although not shown in the figure, the surface magnetic flux density in the case of the comparative example 1 is the same as that in the case of the comparative example 2. On the other hand, the surface magnetic flux density in the case of this embodiment is substantially the same as that in the case of the reference. A fall in the surface magnetic flux density is reduced. The fall in the surface magnetic flux density can be reduced in this way. This is considered to be because of reasons explained below. In the case of this embodiment, the joining section 115ma (see FIG. 5B) formed by hardening the magnetic adhesive 115Bnd is formed in the joint portion 115ct of the annular component 115rng. The magnetic resistance in the joint portion 115ct is considered to have been able to be reduced to relax magnetic discontinuity and reduce the fall in the surface magnetic flux density because the powder of the soft magnetic body is dispersed and included in the joining section 115ma.

FIG. 10 is an explanatory diagram showing eddy current loss characteristics of the coil back yoke according to the embodiment, the reference coil back yoke, and the coil back yoke in a comparative example 2 in comparison with one another. An eddy current loss can be measured by measuring electric power required for rotating a standard motor at the number of revolutions for measurement in a state in which the motors to be measured are connected to the standard motor.

As shown in FIG. 10, the eddy current loss in the case of the comparative example 2 increases more than an increase in the case of the reference according to an increase in the number of revolutions and increases by about maximum 10%. Although not shown in the figure, the eddy current loss in the case of the comparative example 1 is the same as that in the case of the comparative example 2. On the other hand, the eddy current loss in the case of this embodiment is substantially the same as that in the case of the reference. An increase in the eddy current loss is reduced. The eddy current loss can be suppressed in this way. This is considered to be because of reasons explained below. In the case of this embodiment, the joining section 115ma (see FIG. 5B) formed by hardening the magnetic adhesive 115Bnd is formed in the joint portion 115ct of the annular component 115rng. The magnetic resistance in the joint portion 115ct is considered to have been able to be reduced to relax magnetic discontinuity, reduce leak magnetic fluxes from the joint portion 115ct, and reduce an eddy current loss caused by the leak magnetic fluxes because the powder of the soft magnetic body is dispersed and included in the joining section 115ma.

As explained above, the annular component 115rng included in the coil back yoke 115 used in this embodiment has the structure in which the plural divided annular components 115scr having the shape divided along the circumferential direction of the annular ring are stuck together in the annular shape. Therefore, as explained concerning the related art, it is possible to reduce a waste of members and reduce manufacturing costs. The coil back yoke 115 used in this embodiment has the structure in which the annular components 115rng formed in an annular shape by sticking together the divided annular components 115scr are stuck together along the axis direction of the cylinder. However, the coil back yoke 115 has the structure in which the joint portions 115ct of the annular components 115rng are arranged to be shifted in order along the axis direction of the cylinder. Therefore, in the coreless motor 10, it is possible to reduce an integrated amount of cogging torque caused by the joint portions 115ct and suppress occurrence of cogging. In the coil back yoke 115 used in this embodiment, the joint portion 115ct is formed by the joining section 115ma formed by hardening the magnetic adhesive 115Bnd. The powder of the soft magnetic body is dispersed and included in the joining section 115ma. Therefore, it is possible to reduce the magnetic resistance in the joint portion 115ct and relax magnetic discontinuity. Consequently, it is possible to reduce a fall in the surface magnetic flux density of the permanent magnets and reduce occurrence of leak magnetic fluxes from the joint portion 115ct to reduce occurrence of an eddy current loss. For the reasons explained above, in the coreless motor 10 according to this embodiment, it is possible to secure highly accurate positioning, agility excellent in instantaneous torque performance, and excellent driving efficiency and regeneration efficiency.

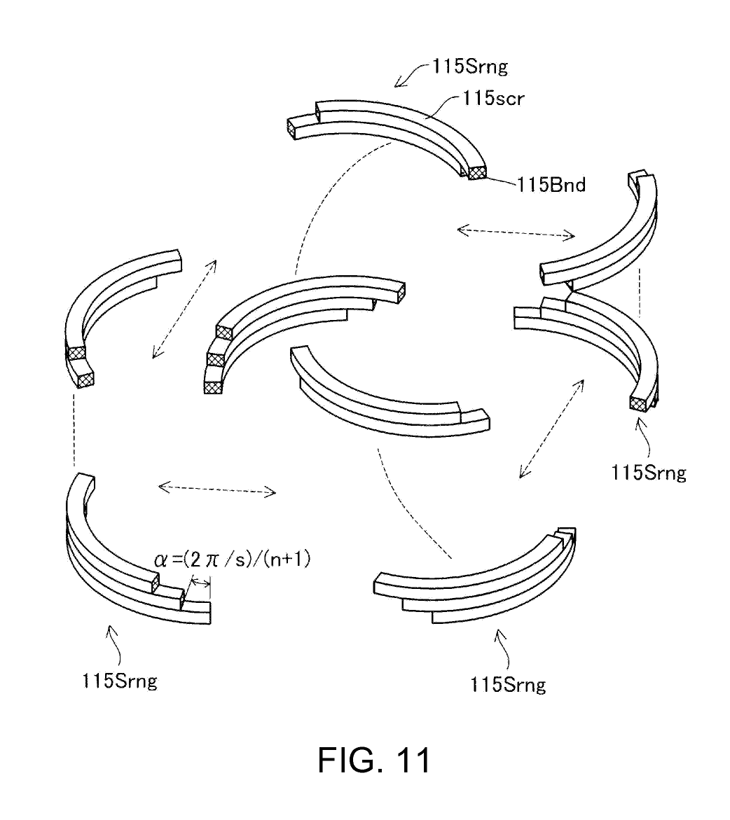

The coil back yoke 115 according to this embodiment can be manufactured according to a procedure explained below as well. FIG. 11 is an explanatory diagram showing another manufacturing procedure for the coil back yoke 115. The divided annular components 115scr provided in the number necessary for forming the coil back yoke 115 can be formed in the same manner as the procedure shown in FIGS. 6A and 6B. As shown in FIG. 11, four sets of divided cylindrical components 115Srng are formed by sticking together two hundred and thirty divided annular components 115scr while arranging the divided annular components 115scr on one surface on the axis (axis of the cylinder of the coil back yoke 115) direction side of the annular ring to be rotated and shifted in order in the circumferential direction of the annular ring by the amount of shift α. The formed four sets of divided cylindrical components 115Srng are stuck together to form a laminated body of the annular components 115rng. When the divided cylindrical components 115Srng are stuck together, the divided cylindrical components 115Srng are stuck together after the magnetic adhesive 115Bnd is applied to at least one of surfaces of the divided annular components 115scr stuck together among surfaces of the divided cylindrical components 115Srng stuck together. Finally, the formed laminated body of the annular components 115rng is heated to harden the insulating adhesive among the annular components 115rng and the magnetic adhesive 115Bnd among the divided annular components 115scr. According to the procedure explained above, the coil back yoke 115 shown in FIG. 5A is formed. The coil back yoke 115 can be easily manufactured according to the manufacturing procedure explained above.

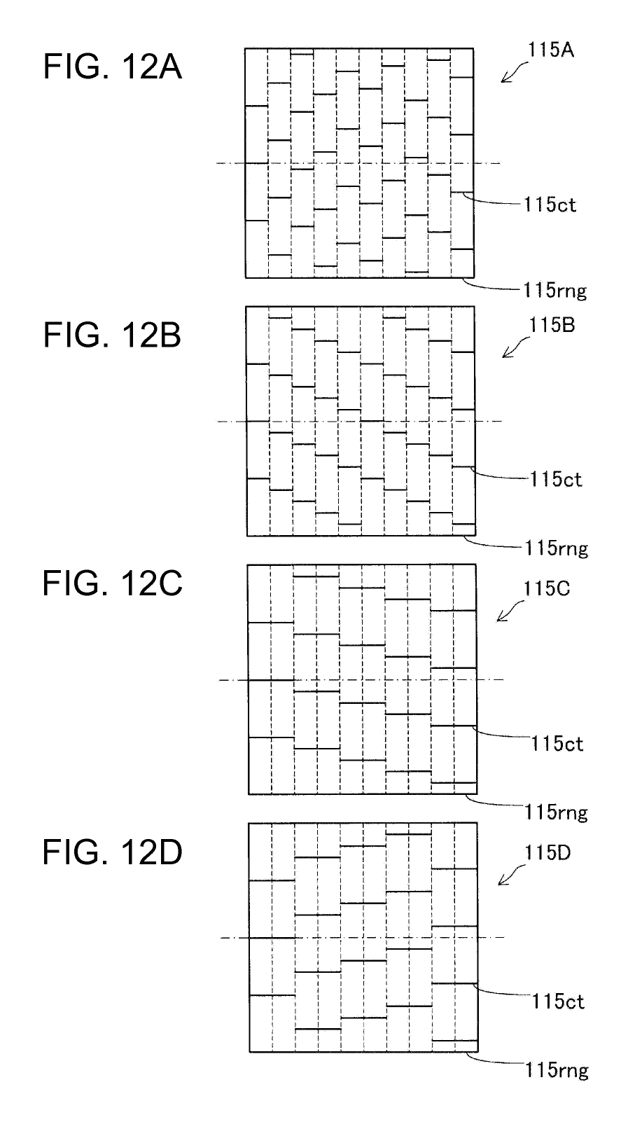

The coil back yoke 115 according to this embodiment in the example explained above has the structure in which the joint portions 115ct of the annular components 115rng are shifted in order along the circumferential direction of the annular ring not to line up on a straight line parallel to the axis direction of the cylinder (indicated by an alternate long and short dash line in the figure). However, the coil back yoke 115 is not always limited to this and may be a coil back yoke having structure explained below. FIGS. 12A to 12D are explanatory diagram schematically showing an expanded plane of a cylindrical surface of a coil back yoke in a modification. To facilitate explanation, it is assumed that the coil back yoke includes ten annular components 115rng.

A coil back yoke 115A shown in FIG. 12A has structure in which the joint portions 115ct of the annular components 115rng are not shifted in order, although shifted from one another as in the embodiment. In this case, it is possible to obtain a cogging reduction effect same as that of the coil back yoke 115 according to the embodiment. However, it is slightly difficult to manufacture the coil back yoke 115A because the joint portions 115ct are not arranged to be shifted in order. A coil back yoke 115B shown in FIG. 12B has structure in which plural joints line up along the axis direction of a cylinder, although the joint portions 115ct are arranged to be shifted in order as in the coil back yoke 115 according to the embodiment. In this case, as in the embodiment, it is possible to obtain the cogging reduction effect, although inferior compared with the embodiment. A coil back yoke 115C shown in FIG. 12C has structure in which the joint portions 115ct are arranged to be shifted in order for each of the plural annular components 115rng. In this case, as in the embodiment, it is possible to obtain the cogging reduction effect, although inferior compared with the embodiment. Since the coil back yoke 115C can be treated in a unit of the plural annular components 115rng, it is easier to manufacture the coil back yoke 115C than manufacturing the coil back yoke 115 in the embodiment. A coil back yoke 115D shown in FIG. 12D has structure in which the joint portions 115c are not shifted in order, although arranged to be shifted for each of the plural annular components 115rng. In this case, as in the embodiment, it is possible to obtain the cogging reduction effect, although inferior compared with the embodiment. Since the coil back yoke 115D can be treated in a unit of the plural annular components 115rng, it is easier to manufacture the coil back yoke 115D than manufacturing the coil back yoke 115 in the embodiment. On the other hand, it is difficult to manufacture the coil back yoke 115D because the joint portions 115ct are not arranged to be shifted in order.

As explained above, the coil back yoke only has to have structure in which the cogging reduction effect can be obtained by dispersing the number of joint portions lining up on a straight line parallel to the axis direction of the cylinder.

### Second Embodiment

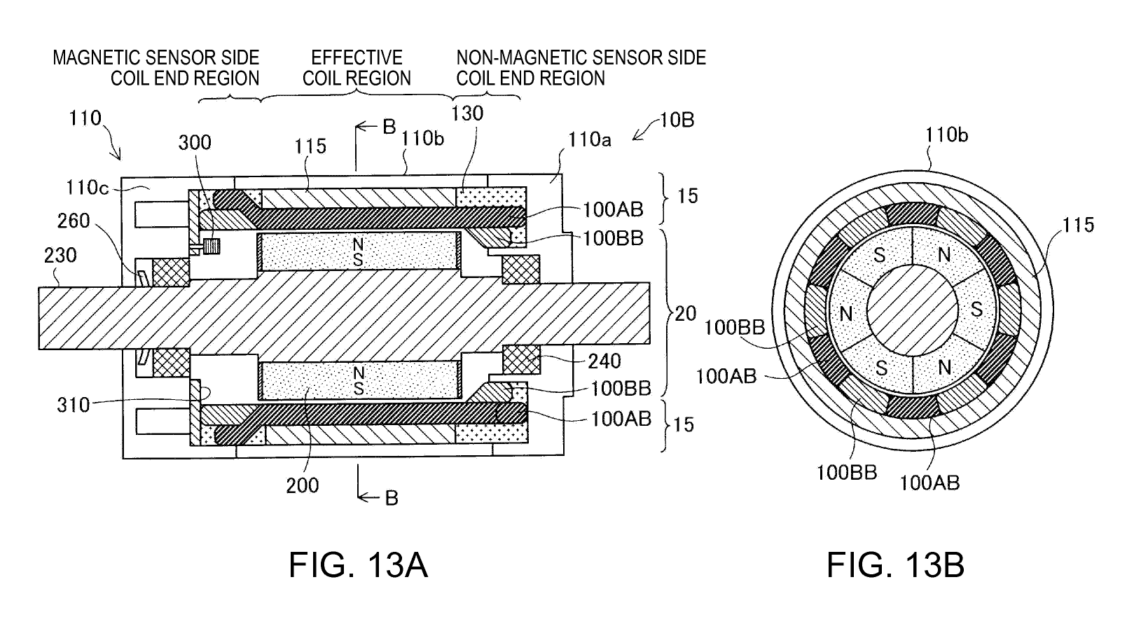

FIGS. 13A and 13B are explanatory diagrams showing a coreless motor according to a second embodiment. FIG. 13A schematically shows a diagram of a schematic cross section of a coreless motor 10B taken along a cutting line parallel to the rotating shaft 230 and viewed from a direction perpendicular to the cross section. FIG. 13B schematically shows a diagram of a schematic cross section of the coreless motor 10B taken along a cutting line (B-B in FIG. 13A) perpendicular to the rotating shaft 230 and viewed from a direction perpendicular to the cross section. The coreless motor 10B according to the second embodiment basically has the same structure as the coreless motor 10 according to the first embodiment except differences explained below. Compared with the first embodiment, in the second embodiment, as shown in FIG. 13B, the number of electromagnetic coils 100AB and 100BB is a half. According to this difference, the size of one pole of the electromagnetic coils 100AB and 100BB according to the second embodiment is larger than the size of one pole of the electromagnetic coils 100A and 100B according to the first embodiment.

In the first embodiment, as shown in FIG. 1B, the coil bundles in the effective coil region of the two electromagnetic coils 100B are fit in between the two coil bundles in the effective coil region of the electromagnetic coil 100A. The coil bundles in the effective coil region of the two electromagnetic coils 100A are fit in between the two coil bundles in the effective coil region of the electromagnetic coil 100B. On the other hand, in the second embodiment, as shown in FIG. 13B, a coil bundle in an effective coil region of one electromagnetic coil 100BB is fit in between two coil bundles in an effective coil region of the electromagnetic coil 100AB. A coil bundle in the effective coil region of one electromagnetic coil 100AB is fit in between two coil bundles in the effective coil region of the electromagnetic coil 100BB. As a result, whereas the electromagnetic coils in the same phase are partially in contact with each other in the first embodiment, the electromagnetic coils in the same phase are not in contact with each other in the second embodiment. According to this difference, whereas, in the first embodiment, as shown in FIG. 3A, the thickness φ1 of the coil bundles in effective coil region of the electromagnetic coils 100A and 100B is about the half size of the space L2 of the coil bundles in the effective coil region, in the second embodiment, the thickness φ1 of the coil bundles in the effective coil region of the electromagnetic coils 100AB and 100BB is substantially the same size as the space L2 of the coil bundles in the effective coil region.

As explained above, the electromagnetic coils 100A and 100B according to the first embodiment and the electromagnetic coils 100AB and 100BB according to the second embodiment are different in a winding method and a combining method of the electromagnetic coils. According to this difference, specifically, whereas, in the first embodiment, as shown in FIG. 1B, the electromagnetic coils in the same phase are partially in contact with each other, in the second embodiment, as shown in FIG. 13B, the part where the electromagnetic coils in the same phase are in contact with each other is eliminated. Consequently, a useless space is reduced to further improve a space factor of the electromagnetic coils than in the first embodiment.

The coil back yoke 115 is applied to the coreless motor 10B according to the second embodiment like the coreless motor 10 according to the first embodiment. Therefore, it is possible to suppress occurrence of cogging. Further, it is possible to reduce a fall in the surface magnetic flux density of the permanent magnets and reduce occurrence of leak magnetic fluxes to reduce occurrence of an eddy current loss.

A coreless motor, which is an electric motor having the characteristics of the invention explained in the embodiments, can be applied as a driving device for an electric mobile body, an electric mobile robot, or a medical apparatus as explained below.

### Third Embodiment

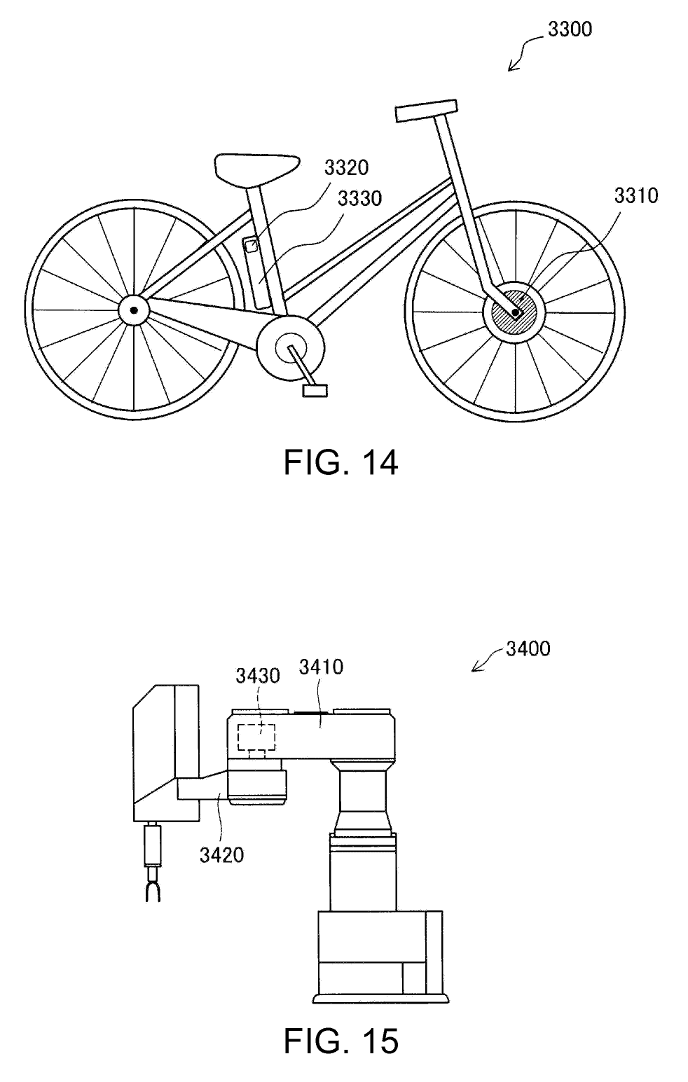

FIG. 14 is an explanatory diagram showing an electric bicycle (an electrically assisted bicycle), which is an example of a mobile body in which a coreless motor having the characteristics of the invention is used. In a bicycle 3300, a motor 3310 is provided in the front wheel and a control circuit 3320 and a rechargeable battery 3330 are provided in a frame under the saddle. The motor 3310 drives the front wheel using electric power from the rechargeable battery 3330 to thereby assist traveling of the bicycle 3300. During braking, electric power regenerated by the motor 3310 is charged in the rechargeable battery 3330. The control circuit 3320 is a circuit that controls the driving and the regeneration of the motor 3310. As the motor 3310, the coreless motors explained above can be used.

### Fourth Embodiment

FIG. 15 is an explanatory diagram showing an example of a robot in which a coreless motor having the characteristics of the invention is used. A robot 3400 includes first and second arms 3410 and 3420 and a motor 3430. The motor 3430 is used in horizontally rotating the second arm 3420 functioning as a driven member. As the motor 3430, cogging-less various coreless motors capable of performing highly accurate positioning can be used.

### Fifth Embodiment

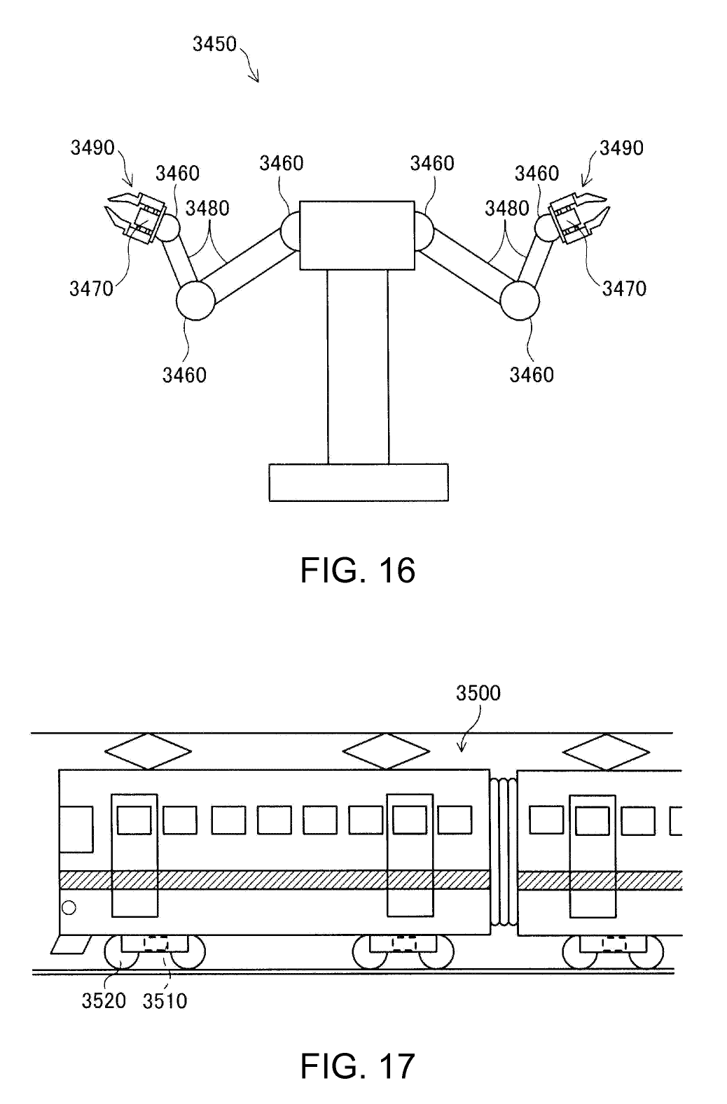

FIG. 16 is an explanatory diagram showing an example of a double-arm 7-axis robot in which a coreless motor having the characteristics of the invention is used. A double-arm 7-axis robot 3450 includes joint motors 3460, grip section motors 3470, arms 3480, and gripping sections 3490. The joint motors 3460 are arranged in positions equivalent to the shoulder joints, the elbow joints and the wrist joints. The joint motors 3460 include two motors for each of the joints in order to cause the arms 3480 and the gripping sections 3490 to three-dimensionally operate. The grip section motors 3470 open and close the gripping sections 3490 to cause the gripping sections 3490 to grip objects. In the double-arm 7-axis robot 3450, as the joint motors 3460 or the grip section motors 3470, various coreless motors having agility excellent in instantaneous torque performance as explained above can be used.

### Sixth Embodiment

FIG. 17 is an explanatory diagram showing a railway vehicle in which a coreless motor having the characteristics of the invention is used. A railway vehicle 3500 includes an electric motor 3510 and a wheel 3520. The electric motor 3510 drives the wheel 3520. The electric motor 3510 is used as a generator during braking of the railway vehicle 3500 to regenerate electric power. As the electric motor 3510, various coreless motors excellent in driving efficiency and regeneration efficiency as explained above can be used.

### Modifications

Among the components in the embodiments, elements other than claimed elements in the independent claims are additional elements and can be omitted as appropriate. The invention is not limited to the examples and the embodiments explained above. The invention can be carried out in various forms without departing from the spirit of the invention.

### Modification 1

In the embodiments, the coreless motors 10 and 10B have the structure in which the magnetic sensor side coil end regions of one electromagnetic coils 100A and 100AB are bent to the outer circumferential side and the non-magnetic sensor side coil end regions of the other electromagnetic coils 100B and 100BB are bent to the inner circumferential side. However, the invention may be a coreless motor having structure in which coil end regions on both sides of one electromagnetic coil are bent to the outer circumferential side or the inner circumferential side and coil end regions on both sides of the other electromagnetic coil are not bent. Further, the invention may be a coreless motor having two-layer arrangement structure in which one electromagnetic coil is arranged along the cylindrical surface and the other electromagnetic coil is arranged in the outer circumference of one electromagnetic coil.

### Modification 2

In the embodiments and the modification, the coreless motor of the inner rotor type is explained as an example. However, the invention may be a coreless motor of an outer rotor type. In the case of the coreless motor of the outer rotor type, permanent magnets of a rotor are arranged in the outer circumference of electromagnetic coils. Therefore, a coil back yoke is arranged along the inner circumferential side of the electromagnetic coils.

### Modification 3

In the embodiments and the modifications, the coreless motors in the case of the two-phase electromagnetic coils are explained as examples. However, the invention is not limited to this and may be a coreless motor including electromagnetic coils in three or more plural phases.

### Modification 4

In the embodiments and the modifications, the coreless motors having the characteristics of the invention are explained as examples. However, the invention is not limited to the coreless motors functioning as electric motors and can also be applied to a generator.

The present application claims the priority based on Japanese Patent Application No. 2011-200428 filed on Sep. 14, 2011, the disclosure of which is hereby incorporated by reference in its entirety.

What is claimed is:

1. A cylindrical coil back yoke arranged, in a coreless electromechanical device including a rotor and a stator, in an inner circumference or an outer circumference of air-core electromagnetic coils arranged along a cylindrical surface in the stator, wherein
the cylindrical coil back yoke has laminated structure in which a plurality of annular components are stuck together along an axis direction of a cylinder,
the annular component is formed of a soft magnetic body and has structure in which a plurality of divided annular components having a shape divided along a circumferential direction of an annular ring are stuck together in an annular shape, and
to prevent joint portions formed in the annular components by sticking together the divided annular components along the circumferential direction of the annular ring from lining up on a straight line parallel to the axis direction of the cylinder, the joint portions of at least a part of the plurality of annular components are stuck together while being shifted along the circumferential direction of the annular ring with respect to the joint portions of the other annular components.

2. The coil back yoke according to claim 1, wherein the annular components are stuck together with the joint portions shifted in order of the lamination along the circumferential direction of the annular ring.

3. The coil back yoke according to claim 2, wherein the joint portions where the divided annular components are stuck together include joining sections formed by a joining member including powder of a soft magnetic body.

4. A coreless electromechanical device including a rotor and a stator, wherein
the rotor includes permanent magnets arranged along a cylindrical surface in the rotor,
the stator includes air-core electromagnetic coils arranged along the cylindrical surface in the stator to be opposed to the permanent magnets and a coil back yoke arranged to be opposed to the permanent magnets across the air-core electromagnetic coils, and
the coil back yoke is the coil back yoke according to claim 3.

5. A mobile body comprising the coreless electromechanical device according to claim 4.

6. A robot comprising the coreless electromechanical device according to claim 4.

7. A method of manufacturing a cylindrical coil back yoke arranged, in a coreless electromechanical device including a rotor and a stator, in an inner circumference or an outer circumference of air-core electromagnetic coils arranged along a cylindrical surface in the stator, the cylindrical coil back yoke having laminated structure in which a plurality of annular components are stuck together along an axis direction of a cylinder, the method comprising:
punching, from a steel plate material, which is a soft magnetic body, divided annular components having a shape equally divided along a circumferential direction of an annular ring of the annular components; and
sticking together the divided annular components along the circumferential direction of the annular ring to form one annular component and, while sticking together the divided annular components over an upper surface in an axis direction side of the annular ring of the formed one annular component, sticking together the divided annular components along the circumferential direction of the annular ring to form next one annular component to thereby form laminated structure in which the plurality of annular components are stuck together along the axis direction of the cylinder, wherein
the forming of the laminated structure includes, to prevent joint portions formed in the annular components by sticking together the divided annular components along the circumferential direction of the annular ring from lining up on a straight line parallel to the axis direction of the cylinder, sticking together the divided annular components corresponding to at least a part of the plurality of annular components while shifting the divided annular components along the circumferential direction of the annular ring.

8. A method of manufacturing a cylindrical coil back yoke arranged, in a coreless electromechanical device including a rotor and a stator, in an inner circumference or an outer circumference of air-core electromagnetic coils arranged along a cylindrical surface in the stator, the cylindrical coil back yoke having laminated structure in which a plurality of annular components are stuck together along an axis direction of a cylinder, the method comprising:
punching, from a steel plate material, which is a soft magnetic body, divided annular components having a shape equally divided along a circumferential direction of an annular ring of the annular components;
forming a plurality of divided cylindrical components formed by sticking together a plurality of the divided annular components along the axis direction of the cylinder; and
sticking together the formed plurality of divided cylindrical components to thereby form laminated structure in which the plurality of annular components are stuck together along the axis direction of the cylinder, wherein
the forming of a plurality of divided cylindrical components includes, to prevent joint portions formed in the annular components by sticking together the divided annular components along the circumferential direction of the annular ring in the forming the laminated structure from lining up on a straight line parallel to the axis direction of the cylinder, sticking together the divided annular components corresponding to at least a part of the plurality of annular components while shifting the divided annular components along the circumferential direction of the annular ring.
